(19) United States
(12) Patent Application Publication
(10) Pub. No.: US 2003/0232120 A1
(43) Pub. Date: Dec. 18, 2003

(54) Method for producing a cereal and fruit mixture and mixture produced therewith

(75) Inventors: Kati Merten, Bielefeld (DE); Dirk Dittmann, Bielefeld (DE); Thomas Rusing, Bielefeld (DE)

Correspondence Address: VENABLE, BAETJER, HOWARD AND CIVILETTI, LLP, P.O. BOX 34385, WASHINGTON, DC, 20043-9998, US

(73) Assignee: Dr. August Oetker Nahrungsmittel KG, Bielefeld (DE)

(21) Appl. No.: 10/460,651

(22) Filed: Jun. 13, 2003

(30) Foreign Application Priority Data
Jun. 14, 2002 (DE) 102 26 553.4

(51) Int. Cl. A23L 1/168

(52) U.S. Cl. 426/618

(57) ABSTRACT

The present patent application describes a method for producing a grain and fruit mixture, which is characterized in that the fruits to be used are fresh or frozen and are steeped in a sugar-type solution before being mixed into the grain mixture.

### BACKGROUND OF THE INVENTION

The fruits in grain and fruit mixtures, in particular muesli, are generally hard and thoroughly dry, owing to the fact that these fruits are already in a dried state when they are added to the grain mixture and because residual moisture is absorbed by the dry flakes. It goes without saying that when using a process of this type, few flavoring agents are released to the cereal contained in this mixture. In addition, various types of fruit such as red currants and black currants, blueberries, strawberries and other types of berry fruits are not suitable for adding to grain and fruit mixtures, namely muesli, produced with the known method without resulting in considerable loss of quality. An attempt is made with the method disclosed in European Patent 0 546 350 to eliminate the above-mentioned disadvantages and for the most part preserve the softness of the fruit material. This is done by using a glycerin solution, containing 0.05-0.5 parts enzymes for 100 parts dried fruit and by allowing the fruit to incubate in contact with the glycerin solution, at a temperature of 40-60° C., until the fruit has absorbed at least 10% glycerin. Similar methods are also described in WO-A-9100022 and DE-A-1692206, namely the use of carbohydrase products, which are any of the various enzymes for catalyzing the hydrolysis of carbohydrates. The process results in additional process steps, namely the drying of the fruits to be used, the preparation of the glycerin solution, as well as the incubation of the fruit in the glycerin. The use of glycerin furthermore results in additional costs for producing the finished product.

### SUMMARY OF THE INVENTION

It is the object of the present invention to create an end product containing soft fruits without foreign additives, the taste of which far exceeds anything achieved with known products and which for the most part preserves the color of the fruits. This object is solved by steeping fresh or frozen fruits in a sugar-type solution and mixing the fresh or frozen fruits steeped with the sugar-type solution with a grain mixture. Alternative solutions follow from the following description and claims.

### DETAILED DESCRIPTION OF THE INVENTION

According to the instant invention, a grain and fruit mixture, such as muesli, may be produced where the fruits added to the grain are not dried first. That is, either fresh or frozen fruits are steeped in a sugar-type solution and then mixed with a grain mixture. As a result of this method, the fruits are not freeze-dried or dried first so that the resultant fruit and grain mixture has softer fruits without foreign additives.

According to one embodiment of the invention, fresh or frozen fruit having a diameter that exceeds approximately 1.5 cm to 2 cm may be chopped up into fruit sections of predetermined sizes. The prepared fruits may then be processed in a specific fruit preparation, according to the invention, by adding sugar-type solutions, preferably a sucrose or glucose syrup solution, in which the fruit are steeped. Another embodiment of the invention further envisions adding flavoring substances, culinary acids and/or gelatinizing and thickening agents to the prepared fruits.

These pre-treatments of the fruits ensure that the authentic appearance, consistency and/or texture, as well as the taste, are mostly preserved.

The prepared fruits may be added to the grain mixture together with the steeping solution, in which the flavoring agents and also the coloring agents from the fruits may have been added. The grain mixture, as defined according to the present invention, relates to grains and/or grain products, such as are used for commercially available muesli mixtures. In addition to including flaked or crushed edible grains (preferably oatmeal), the grain mixtures can also include highly processed, special grain products, e.g. created through extruding, flaking, roasting, etc. (preferably so-called cereals such as corn flakes, extruded grains, puffed wheat etc.), wherein cereals can form the largest share.

When the fruit preparation is added to the grain, the grain mixture results in the flavoring agents of the fruits being absorbed by the mixture. This fruit and grain mixture is then roasted until the residual water content measures between 1 and 7% residual moisture.

Surprising, the color and taste of the fruit are for the most part retained as a result of using the above-described method of preparing fruits and roasting of same together with the grain mixture. The new method also permits the very careful processing of so-called problem fruits such as strawberries, red currants and black currants, blueberries and the like.

We claim:

1. A method for producing a grain and fruit mixture, comprising the steps of:
steeping one of fresh fruits and frozen fruits in a sugar-type solution; and then, mixing the steeped fruits to a grain resulting in a grain and fruit mixture.

2. The method according to claim 1, further comprising the step of adding one of flavoring agents, culinary acids, and gelatinizing and thickening agents to the one of the fresh fruits and frozen fruits that are used.

3. The method according to claim 1, wherein the one of the fresh fruits and frozen fruits have a diameter of more than approximately 1.5 cm to 2 cm and further comprising the step of chopping up the one of the fresh fruits and frozen fruits into predetermined sizes, prior to steeping the same the sugar-type solution.

4. The method according to claim 1, further comprising the step of drying the fruits together with the grain mixture until they have a residual water content of 1-7% relative to the total mass.

5. A grain and fruit mixture, characterized in that it is produced with fruits that are not first dried.

6. The grain and fruit mixture according to claim 5, wherein the mixture is muesli.
